(19) United States
(12) Patent Application Publication
(10) Pub. No.: US 2015/0134234 A1
(43) Pub. Date: May 14, 2015

(54) APPARATUS FOR DETERMINING MOTION CHARACTERISTICS OF TARGET AND DEVICE FOR CONTROLLING DRIVING ROUTE OF VEHICLE INCLUDING THE SAME

(71) Applicant: HYUNDAI MOBIS CO., LTD., Seoul (KR)

(72) Inventor: Jeong Ku KIM, Yongin (KR)

(21) Appl. No.: 14/333,149

(22) Filed: Jul. 16, 2014

(30) Foreign Application Priority Data
Nov. 13, 2013 (KR) 10-2013-0137399

(51) Int. Cl. G01C 21/34; G01S 17/93; G01S 13/93

(52) U.S. Cl. CPC G01C 21/34; G01S 13/931; G01S 17/936
USPC 701/408

(57) ABSTRACT

Disclosed are an apparatus for determining motion characteristics of a target, which determines whether a target positioned in front of a vehicle is a moving object and a movement direction of the target when the target is the moving object and adjusts a driving route of the vehicle based on a determination result of motion characteristics of the target, and a device for controlling a driving route of a vehicle including the same.

### CROSS-REFERENCE TO RELATED APPLICATIONS

This application claims priority to and the benefit of Korean Patent Application No. 10-2013-0137399 filed in the Korean Intellectual Property Office on Nov. 13, 2013, the entire contents of which are incorporated herein by reference.

### TECHNICAL FIELD

The present invention relates to an apparatus for determining motion characteristics of a target that determines whether a target is positioned in front of the vehicle and adjusts a driving route of a vehicle based on information on the target and a device for controlling a driving route of a vehicle including the same.

### BACKGROUND ART

A vehicle in the related art has a map generation function using a general camera, a map generation function using a stereo camera, a map generation function using a 3D laser scanner, and the like and controls driving of the vehicle by using object information acquired based on the functions and a navigation device.

The vehicle in the related art determines an object positioned outside by matching consecutive images acquired from the stereo camera at the time of generating a map by using the stereo camera and determines the object by generating an outside as 3D information at the time of generating the map by using the 3D laser scanner.

However, when the general camera is used, distance information is not accurate and when the stereo camera is used, an array depending on a position is changed, and as a result, a matching operation is difficult. When the 3D laser scanner is used, accuracy of the distance information is increased, but a data capacity to be processed is increased and an expensive sensor is used, and as a result, manufacturing cost is increased.

Korean Patent Publication No. 2012-0053313 discloses a method for sensing an object in front and controlling a driving route of a vehicle based on a sensing result. However, since this method senses only whether the object is positioned in a specific area, it is difficult to actively react to a motion of the object.

### SUMMARY OF THE INVENTION

The present invention has been made in an effort to provide an apparatus for determining motion characteristics of a target, which determines whether a target positioned in front of a vehicle is a moving object and a movement direction of the target when the target is the moving object and adjusts a driving route of the vehicle based on a determination result of motion characteristics of the target, and a device for controlling a driving route of a vehicle including the same.

However, the objects of the present invention are not limited to the aforementioned objects, and other objects, which are not mentioned above, will be apparent to those skilled in the art from the following description.

An exemplary embodiment of the present invention provides a device for controlling a driving route, including: a presence determining unit determining whether a target is positioned in front; a moving object/movement direction determining unit determining whether the target is a moving object and a movement direction of the target by using a relative speed deviation of the target when it is determined that the target is positioned in front; and a driving route controlling unit controlling a driving route of a vehicle based on whether the target is the moving object and the movement direction of the target when the target is the moving object.

The presence determining unit may determine that the target is positioned in front when at least one signal of a radar signal, a laser signal and a camera signal output in front is input within a predetermined time.

The moving object/movement direction determining unit may include a first relative speed estimating unit measuring a first longitudinal speed and a first transverse speed of the vehicle and estimating a first longitudinal relative speed and a first transverse relative speed of the target based on the first longitudinal speed and the first transverse speed; a second relative speed estimating unit measuring a second longitudinal speed and a second transverse speed of the vehicle after a predetermined time elapses and estimating a second longitudinal relative speed and a second transverse relative speed of the target based on the second longitudinal speed and the second transverse speed; and a relative speed comparing unit determining whether the target is the moving object and the movement direction of the target based on a result of comparing the first longitudinal relative speed and the second longitudinal relative speed and a result of comparing the first transverse relative speed and the second transverse relative speed.

The relative speed comparing unit may determine that the target is not the moving object when a difference value between the first longitudinal relative speed and the second longitudinal relative speed is equal to the first longitudinal relative speed and when a difference value between the first transverse relative speed and the second transverse relative speed is equal to the first transverse relative speed.

The relative speed comparing unit may determine that the target moves in a left direction when a difference value between the first longitudinal relative speed and the second longitudinal relative speed is larger than the first longitudinal relative speed, determine that the target moves in a right direction when the difference value between the first longitudinal relative speed and the second longitudinal relative speed is smaller than the first longitudinal relative speed, determine that the vehicle and the target are close to each other when a difference value between the first transverse relative speed and the second transverse relative speed is larger than the first transverse relative speed on the road, and determine that the vehicle and the target are distant from each other on the road when the difference value between the first transverse relative speed and the second transverse relative speed is smaller than the first transverse relative speed.

The device may further include: a distance measuring unit measuring a distance up to the target every predetermined time when it is determined that the target is positioned in front; and a distance determining unit determining whether the distance up to the target is equal to or less than a reference distance, wherein the moving object/movement direction determining unit may determine whether the target is the moving object and the movement direction of the target when it is determined that the distance up to the target is equal to or less than a reference distance.

The driving route controlling device may be mounted on an unmanned vehicle.

The moving object/movement direction determining unit may determine whether the target is the moving object based on a positional variation amount of the vehicle and a distance variation amount up to the target from the vehicle when it is determined that the target is positioned in front.

The moving object/movement direction determining unit may include a first distance measuring unit measuring a first distance up to the target from the vehicle; a vehicle position estimating unit estimating a first position of the vehicle for a first position of the target based on the first distance; a second distance measuring unit measuring a second distance up to the target from the vehicle after a predetermined time elapses; a vehicle position deciding unit deciding a second position of the vehicle from the first position of the vehicle based on a longitudinal speed and a transverse speed of the vehicle after the predetermined time elapses; a target position estimating unit estimating a second position of the target based on the second distance and the second position of the vehicle; and a position comparing unit comparing the first position of the target and the second position of the target to determine whether the target is the moving object.

Another exemplary embodiment of the present invention provides an apparatus for determining motion characteristics of a target, including: a presence determining unit determining whether a target is positioned in front; and a moving object/movement direction determining unit determining whether the target is a moving object and a movement direction of the target by using a relative speed deviation of the target when it is determined that the target is positioned in front.

According to exemplary embodiments of the present invention, the following effects can be achieved by determining whether a target positioned in front of a vehicle is a moving object and a movement direction of the target when the target is the moving object and controlling a driving route of the vehicle based on a determination result of motion characteristics of the target.

First, a driving map is generated by organizing an external object so that an unmanned vehicle is drivable around an external object while a GPS is absent/lost, thereby ensuring robustness of the unmanned vehicle.

Second, merchantability of a vehicle can be increased, and as a result, an increase in sales and profit is expected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a device for controlling a driving route of a vehicle according to an exemplary embodiment of the present invention.

FIG. 2 is a block diagram illustrating, in detail, a moving object/a movement direction determination unit constituting the device for controlling a driving route according to the exemplary embodiment of the present invention.

FIG. 3 is a block diagram schematically illustrating an object determining system according to an exemplary embodiment of the present invention.

FIG. 4 is a reference diagram for describing a method for deciding a control target object among front objects.

FIGS. 5A and 5B are reference diagrams for describing a method for estimating a movement direction of the target control object.

FIG. 6 is a flowchart for describing a method for determining whether the control target object is a moving object and a movement direction.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. When reference numerals refer to components of each drawing, it is to be noted that although the same components are illustrated in different drawings, the same components are denoted by the same reference numerals as possible. In describing the embodiments of the present invention, when it is determined that the detailed description of the known art related to the present invention may obscure the gist of the present invention, the detailed description thereof will be omitted. Hereinafter, exemplary embodiments of the present invention will be described. However, it should be understood that a technical spirit of the invention is not limited to the specific embodiments, but may be changed or modified by those skilled in the art.

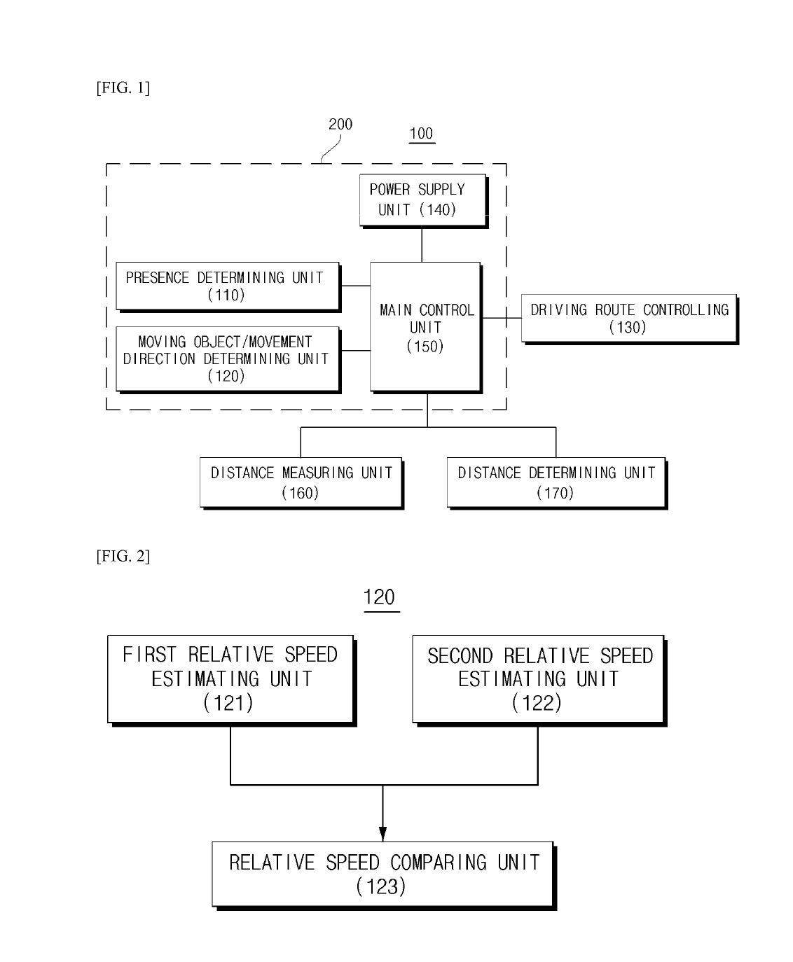

FIG. 1 is a block diagram schematically illustrating a device for controlling a driving route according to an exemplary embodiment of the present invention. In FIG. 1, an apparatus 200 for determining motion characteristics of a target determines whether a target positioned in front of a vehicle is a moving object and a movement direction of the target when the target is the moving object. The driving route controlling device 100 adjusts a driving route of the vehicle based on a determination result of the motion characteristics of the target.

According to FIG. 1, the driving route controlling device 100 includes a presence determining unit 110, a moving object/movement direction determining unit 120, a driving route controlling unit 130, a power supply unit 140, and a main control unit 150.

The power supply unit 140 serves to supply power to respective components constituting the driving route controlling device 100. The main control unit 150 serves to control all operations of the respective components constituting the driving route controlling device 100. When it is considered that the driving route controlling device 100 may be mounted on an ECU that controls functions associated with driving of the vehicle, the power supply unit 140 and the main control unit 150 may not be included in the driving route controlling device 100.

The presence determining unit 110 serves to determine whether the target is positioned in front of the vehicle. The presence determining unit 110 may determine that the target is positioned in front when at least one signal of a radar signal, a laser signal and a camera signal output to the front is returned and input within a predetermined time. The above-mentioned laser signal means a scanned signal by a laser scanner of vehicle.

The moving object/movement direction determining unit 120 serves to determine whether the target is the moving object and the movement direction of the target by using a relative speed deviation of the target when the presence determining unit 110 determines that the target is positioned in front of the vehicle.

FIG. 2 is a block diagram illustrating, in detail, an internal configuration of the moving object/movement direction determining unit 120. According to FIG. 2, the moving object/movement direction determining unit 120 may include a first relative speed estimating unit 121, a second relative speed estimating unit 122, and a relative speed comparing unit 123.

The first relative speed estimating unit 121 serves to measure a first longitudinal speed and a first transverse speed of the vehicle. The first relative speed estimating unit 121 serves to estimate a first longitudinal relative speed and a first transverse relative speed of the target based on the first longitudinal speed and the first transverse speed.

The second relative speed estimating unit 122 serves to measure a second longitudinal speed and a second transverse speed of the vehicle after a predetermined time elapses. The second relative speed estimating unit 122 serves to estimate a second longitudinal relative speed and a second transverse relative speed of the target based on the second longitudinal speed and the second transverse speed.

The relative speed comparing unit 123 serves to determine whether the target is the moving object and the movement direction of the target based on a result of comparing the first longitudinal relative speed and the second longitudinal relative speed and a result of comparing the first transverse relative speed and the second transverse relative speed.

When it is judged whether the target is the moving body, the relative speed comparing unit 123 first calculates a difference value (hereinafter, defined as a longitudinal relative speed difference value) between the first longitudinal relative speed and the second longitudinal relative speed and a difference value (hereinafter, defined as a transverse relative speed difference value) between the first transverse relative speed and the second transverse relative speed. Thereafter, the relative speed comparing unit 123 compares the longitudinal relative speed difference value and the first longitudinal relative speed and compares the transverse relative speed difference value and the second transverse relative speed. According to the comparison result, if the longitudinal relative speed difference value and the first longitudinal relative speed are equal to each other and the transverse relative speed difference value and the first transverse relative speed are equal to each other, the relative speed comparing unit 123 determines the target as a fixed object. On the contrary, when the comparison result is not so, the relative speed comparing unit 123 determines the target as the moving object.

Meanwhile, when the target is the moving object, in order to determine the movement direction of the target, the relative speed comparing unit 123 first calculates the longitudinal relative speed difference value and the transverse relative speed difference value. Thereafter, the relative speed comparing unit 123 compares the longitudinal relative speed difference value and the first longitudinal relative speed and compares the transverse relative speed difference value and the second transverse relative speed. According to the comparison result, if the longitudinal relative speed difference value is larger than the first longitudinal relative speed, the relative speed comparing unit 123 determines that the target moves in a left direction. According to the comparison result, if the longitudinal relative speed difference value is smaller than the first longitudinal relative speed, the relative speed comparing unit 123 determines that the target moves in a right direction. According to the comparison result, if the transverse relative difference value is larger than the first transverse relative speed, the relative speed comparing unit 123 determines that a distance between the vehicle and the target is decreased on a road (that is, the target is close to the vehicle). According to the comparison result, if the transverse relative speed difference value is smaller than the first transverse relative speed, the relative speed comparing unit 123 determines that the distance between the vehicle and the target is increased on the road (that is, the target is distant from the vehicle).

The configuration will be described by referring back to FIG. 1.

The driving route controlling unit 130 serves to control the driving route of the vehicle based on whether the target is the moving object and the movement direction of the target when the target is moving object.

Meanwhile, although the objects are positioned in front, the moving object/movement direction determining unit 120 may use only an object which meets a specific reference as the target. The driving route controlling device 100 may further include a distance measuring unit 160 and a distance determining unit 170 by considering such a point.

The distance measuring unit 160 serves to measure a distance up to the target every predetermined time when it is judged that the target is positioned in front.

The distance determining unit 170 serves to compare the distance up to the target measured by the distance measuring unit 160 with a reference distance to determine whether the distance up to the target is equal to or less than the reference distance.

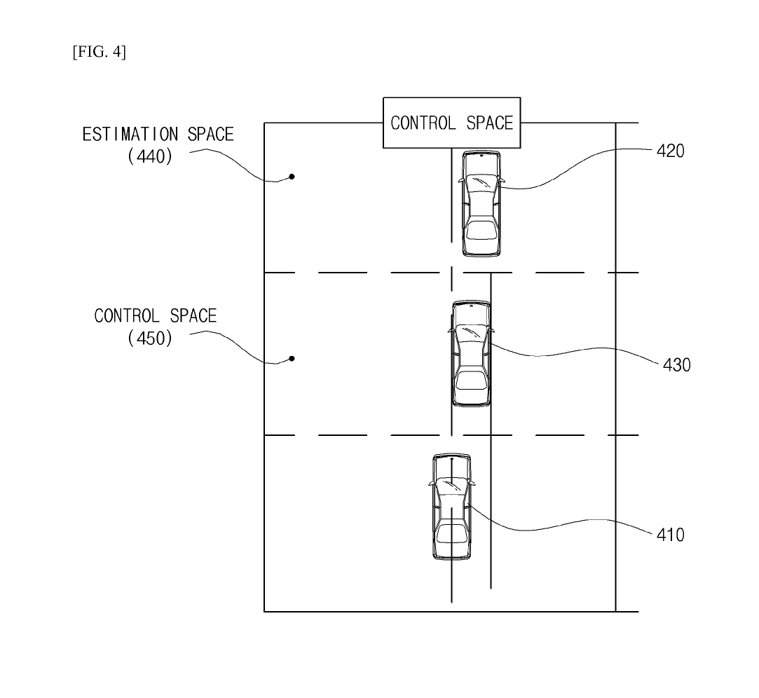

When the driving route controlling device 100 further includes the distance measuring unit 160 and the distance determining unit 170, the moving object/movement direction determining unit 130 may determine whether the target is the moving object and the movement direction of the target only for the target when it is determined that the distance up to the target is equal to or less than the reference distance. Although described below with reference to FIG. 4, the moving object/movement direction determining unit 130 may determine that the target enters a control space from an estimated space when the distance up to the target is equal to or less than the reference distance and set the target as a tracking target from that time

Meanwhile, the moving object/movement direction determining unit 120 may determine whether the target is the moving object based on a positional variation amount of the vehicle and a distance variation amount up to the target from the vehicle when it is determined that the target is positioned in front.

When such a point is considered, the moving object/movement direction determining unit 120 may include a first distance measuring unit (not illustrated), a vehicle position estimating unit (not illustrated), a second distance measuring unit (not illustrated), a vehicle position deciding unit (not illustrated), a target position estimating unit (not illustrated), and a position comparing unit (not illustrated).

The first distance measuring unit serves to measure a first distance up to the target from the vehicle.

The vehicle position estimating unit performs a function to estimate a first position of the vehicle for a first position of the target based on the first distance.

The second distance measuring unit serves to measure a second distance up to the target from the vehicle after a predetermined time elapses.

The vehicle position deciding unit serves to decide the second position of the vehicle from the first position of the vehicle based on a longitudinal speed and a transverse speed of the vehicle after the predetermined time elapses.

The target position estimating unit serves to estimate the second position of the target based on the second distance and the second position of the vehicle.

The position comparing unit serves to determine whether the target is the moving object by comparing the first position of the target and the second position of the target.

Hereinabove, the driving route controlling device 100 according to the exemplary embodiment of the present invention has been described with reference to FIGS. 1 and 2. The driving route controlling device 100 according to the present invention is contrived to be operated while being mounted on an unmanned vehicle.

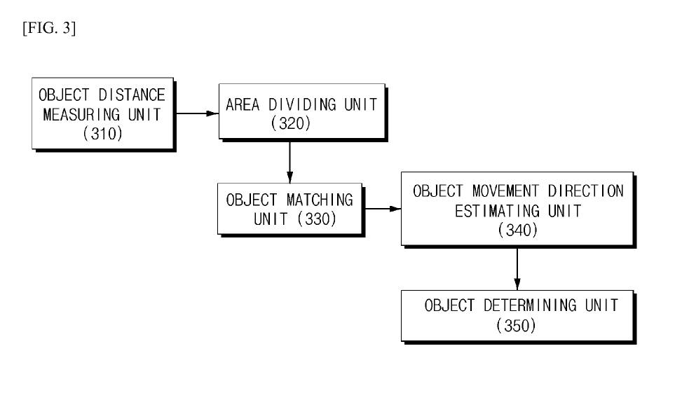

Hereinafter, the present invention will be described in detail as an executable implementation example. FIG. 3 is a block diagram schematically illustrating an object determining system according to an exemplary embodiment of the present invention.

The present invention relates to a method for determining the fixed object by using a distance measuring sensor in an autonomous driving vehicle.

The unmanned vehicle driven unmannedly requires a capability to recognize the external object by using the distance measuring sensor. The unmanned vehicle may calculate the distance up to the target by the capability and verify whether the external object is the moving object or the fixed object by using the distance. The unmanned vehicle may be safely driven only when the position and a moving route of the external object are known in order to extract a drivable space.

The present invention aims at generating a driving map for determining the position and the moving route of the external object by using the distance measuring sensor and generating the driving route of the unmanned vehicle. The present invention aims at generating the driving map by determining stopping or moving of an object with information on the distance measured from a driving vehicle by using the distance measuring sensor.

Referring to FIG. 3, the object determining system includes an object distance measuring unit 310, an area dividing unit 320, an object matching unit 330, an object movement direction estimating unit 340, and an object determining unit 350.

The object distance measuring unit 310 serves to sense an object positioned outside and measure a distance up to the object.

The area dividing unit 320 serves to divide a front space of the vehicle into an estimation space and a control space based on the distance measured by the object distance measuring unit 310. The estimation space and the control space will be described with reference to FIG. 4.

The object matching unit 330 serves to locate a fixing point of the position of the external object before an object sensed in the estimation space enters the control space at a position where a driving vehicle speed is calculated and match the located fixing point with the time when the object sensed in the estimation space enters the control space. In this case, the object matching unit 330 performs matching by considering a time delay based on a detection result of the object distance measuring unit 310.

The object movement direction estimating unit 340 serves to estimate the movement direction of the object by calculating a deviation after the matching.

The object determining unit 350 serves to finally determine an object of which the movement direction is estimated.

FIG. 4 is a reference diagram for describing a method for deciding a control target object among front objects. In detail, FIG. 4 illustrates object tracking using a relative speed of an object sensed in a driving vehicle.

First, when an object 420 is detected in an estimation space 440, the object 420 is tracked. Thereafter, the object 420 of the estimation space 440 is matched with a control target object of the control space 450, that is, a target 430 by considering a movement speed of the vehicle 410. The object 420 of the estimation space 440 is projected to the control space 450 after a predetermined time elapses to perform the matching. Thereafter, a relative speed depending on the position of the target 430 of the control space 450 is calculated based on a speed of the vehicle 410. Thereafter, a movement direction of the target 430 is estimated.

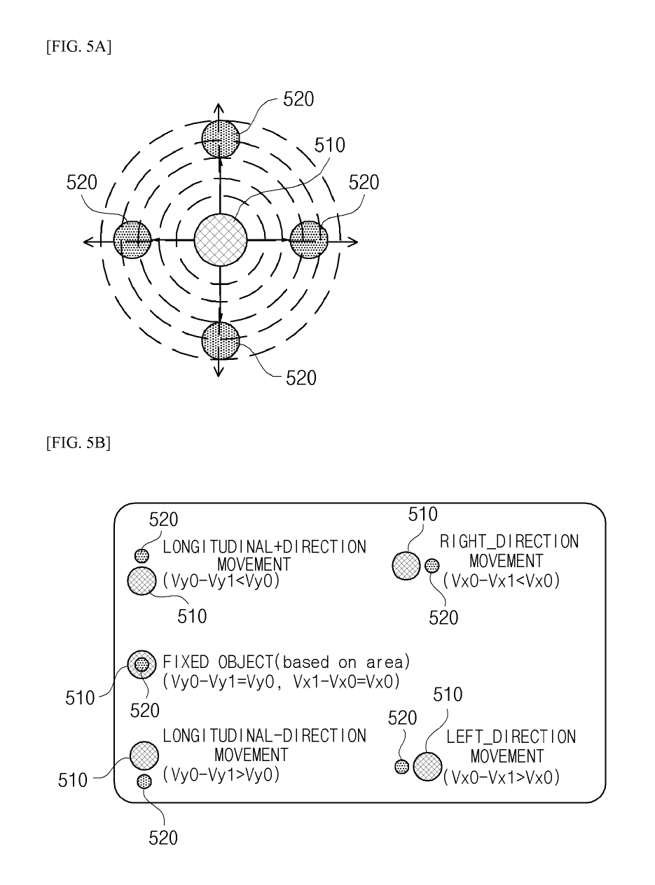

FIGS. 5A and 5B are reference diagrams for describing a method for estimating a movement direction of the target control object. In detail, FIGS. 5A and 5B illustrate a method for estimating the movement direction of the target by using a feature point deviation.

FIG. 5A illustrates a graph acquired by matching the control target object, that is, the target in the control space every predetermined cycle. If the target is the fixed object, the target is principally positioned at the center in the graph of FIG. 5A like reference numeral 510. However, if the target is the moving object, the target is positioned at a specific position out of the center like reference numeral 520.

FIG. 5B illustrates a calculation equation to determine whether the target is a fixed object or moving object. In FIG. 5B, V_{ξ0} represents the first longitudinal relative speed of the target acquired from the first longitudinal speed of the vehicle. V_{ξ1} represents the second longitudinal relative speed of the target acquired from the second longitudinal speed of the vehicle. In the above description, the second longitudinal speed represents the measured longitudinal speed of the vehicle within a predetermined time after measuring the first longitudinal speed.

Meanwhile, V_{ψ0} represents the first transverse relative speed of the target acquired from the first transverse speed of the vehicle. V_{ψ1} represents the second transverse relative speed of the target acquired from the second transverse speed of the vehicle. In the above description, the second transverse speed represents the measured transverse speed of the vehicle within a predetermined time after measuring the first transverse speed. In the exemplary embodiment, the second longitudinal speed and the second transverse speed are measured at the same time.

In FIG. 5B, V_{ξ0}−V_{ξ1}=V_{ξ0} and if V_{ψ0}−V_{ψ1}=V_{ψ0}, the target is determined as the fixed object. In other cases, the target is determined as the moving object, which will be described below in detail.

First, if V_{ξ0}−V_{ξ1}<V_{ξ0}, it is determined that the target moves in a right direction.

Second, if V_{ξ0}−V_{ξ1}>V_{ξ0}, it is determined that the target moves in a left direction.

Third, if V_{ψ0}−V_{ψ1}<V_{ψ0}, it is determined that the target moves in a + longitudinal direction. That is, it is determined that the target and the vehicle are distant from each other.

Fourth, if V_{ψ0}−V_{ψ1}>V_{ψ0}, it is determined that the target moves in a − longitudinal direction. That is, it is determined that the target and the vehicle are close to each other.

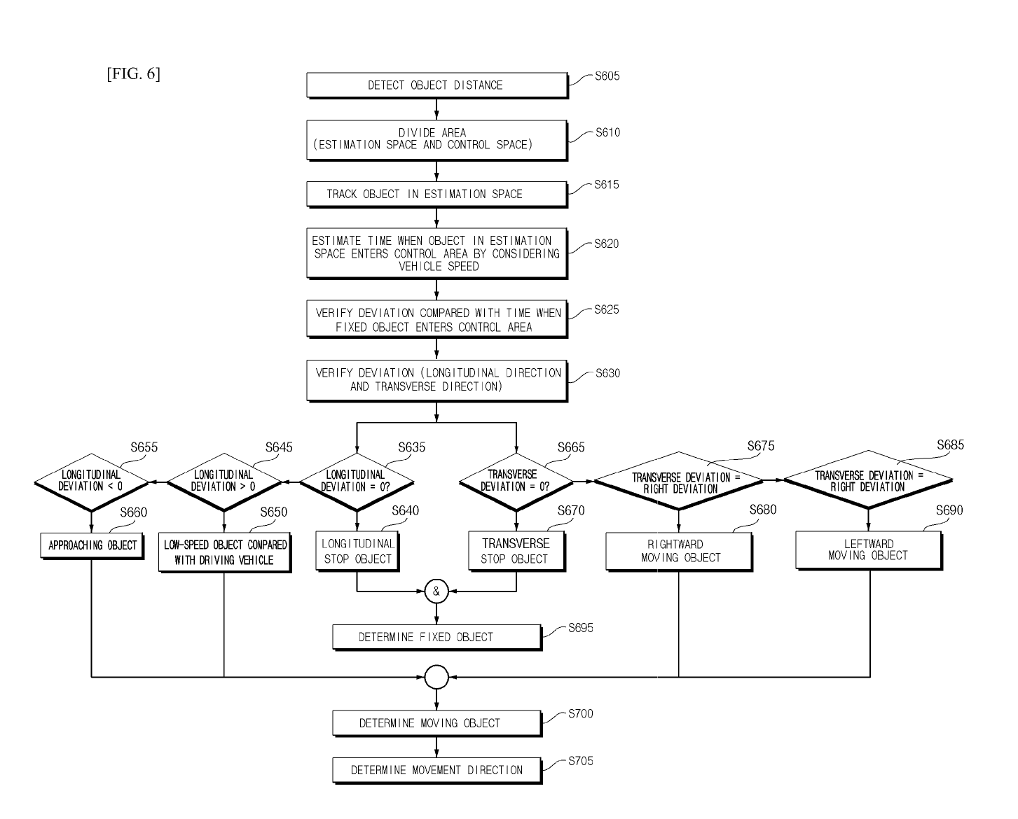

FIG. 6 is a flowchart for describing a method for determining whether the control target object is a moving object and a movement direction.

First, a target positioned outside is detected and a distance up to the target is measured (S605). Thereafter, a front space of a vehicle is divided into an estimation space and a control space (S610). Thereafter, a target positioned in the estimation space is tracked (S615) and the time when the target positioned in the estimation space enters the control space is estimated by considering a speed of the vehicle (S620). Thereafter, a deviation compared with the entering time into the control space is verified (S625). The deviation is verified by dividing a longitudinal component and a transverse component (S630).

Thereafter, it is determined whether the longitudinal deviation is 0 (S635). When the longitudinal deviation is 0, the target is determined as a longitudinal stop object (S640). When the longitudinal deviation is not 0, it is determined whether the longitudinal deviation is larger than 0 (S645). When the longitudinal deviation is larger than 0, the target is determined as a low-speed object compared with the vehicle (S650). When the longitudinal deviation is not larger than 0 (S655), it is meant that the longitudinal deviation is smaller than 0, and as a result, the target is determined as an approaching object (S660).

Meanwhile, it is determined whether the transverse deviation is 0 (S665). When the transverse deviation is 0, the target is determined as a transverse stop object (S670). When the transverse deviation is not 0, it is determined whether the transverse deviation is equal to a right deviation (S675). When the transverse deviation is equal to the right deviation, the target is determined as a right movement object (S680). When the transverse deviation is not equal to the right deviation (S685), it is meant that the transverse deviation is equal to a left deviation, and as a result, the target is determined as a left movement object (S690).

When both the longitudinal deviation and the transverse deviation are determined as 0 through the determination process, the target is finally determined as a fixed object (S695).

As described above, in other cases, all targets are determined as moving objects (S700) and the movement direction of the target is finally decided (S705).

Hereinabove, the object determining system according to the exemplary embodiment of the present invention has been described with reference to FIGS. 3 to 6. Features of the object determining system described above will be organized below.

First, the front space is divided into the estimation space and the control space by using information on a distance between the object and the vehicle, which is measured in the vehicle which is driven unmannedly.

Second, the object estimated in the estimation space is primarily determined as the stop object and is previously estimated by considering the driving speed of the unmanned vehicle.

Third, when the tracked object enters the control space, a deviation from the determined position is calculated.

Fourth, the movement direction of the object is estimated by using the deviation.

Fifth, it is determined whether the object is the fixed object or the moving object by using estimation information of the object.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A device for controlling a driving route, comprising:
a presence determining unit determining whether a target is positioned in front;
a moving object/movement direction determining unit determining whether the target is a moving object and a movement direction of the target by using a relative speed deviation of the target when it is determined that the target is positioned in front; and
a driving route controlling unit controlling a driving route of a vehicle based on whether the target is the moving object and the movement direction of the target when the target is the moving object.

2. The device of claim 1, wherein the presence determining unit determines that the target is positioned in front when at least one signal of a radar signal, a laser signal and a camera signal output in front is input within a predetermined time.

3. The device of claim 1, wherein the moving object/movement direction determining unit includes:
a first relative speed estimating unit measuring a first longitudinal speed and a first transverse speed of the vehicle and estimating a first longitudinal relative speed and a first transverse relative speed of the target based on the first longitudinal speed and the first transverse speed;
a second relative speed estimating unit measuring a second longitudinal speed and a second transverse speed of the vehicle after a predetermined time elapses and estimating a second longitudinal relative speed and a second transverse relative speed of the target based on the second longitudinal speed and the second transverse speed; and
a relative speed comparing unit determining whether the target is the moving object and the movement direction of the target based on a result of comparing the first longitudinal relative speed and the second longitudinal relative speed and a result of comparing the first transverse relative speed and the second transverse relative speed.

4. The device of claim 3, wherein the relative speed comparing unit determines that the target is not the moving object when a difference value between the first longitudinal relative speed and the second longitudinal relative speed is equal to the first longitudinal relative speed and when a difference value between the first transverse relative speed and the second transverse relative speed is equal to the first transverse relative speed.

5. The device of claim 3, wherein the relative speed comparing unit determines that the target moves in a left direction when a difference value between the first longitudinal relative speed and the second longitudinal relative speed is larger than the first longitudinal relative speed, determines that the target moves in a right direction when the difference value between the first longitudinal relative speed and the second longitudinal relative speed is smaller than the first longitudinal relative speed, determines that the vehicle and the target are close to each other on the road when a difference value between the first transverse relative speed and the second transverse relative speed is larger than the first transverse relative speed, and determines that the vehicle and the target are distant from each other when the difference value between the first transverse relative speed and the second transverse relative speed is smaller than the first transverse relative speed on the road.

6. The device of claim 1, further comprising:
a distance measuring unit measuring a distance up to the target every predetermined time when it is determined that the target is positioned in front; and
a distance determining unit determining whether the distance up to the target is equal to or less than a reference distance,
wherein the moving object/movement direction determining unit determines whether the target is the moving object and the movement direction of the target when it is determined that the distance up to the target is equal to or less than a reference distance.

7. The device of claim 1, wherein the driving route controlling device is mounted on an unmanned vehicle.

8. The device of claim 1, wherein the moving object/movement direction determining unit determines whether the target is the moving object based on a positional variation amount of the vehicle and a distance variation amount up to the target from the vehicle when it is determined that the target is positioned in front.

9. The device of claim 8, wherein the moving object/movement direction determining unit includes:
a first distance measuring unit measuring a first distance up to the target from the vehicle;
a vehicle position estimating unit estimating a first position of the vehicle for a first position of the target based on the first distance;
a second distance measuring unit measuring a second distance up to the target from the vehicle after a predetermined time elapses;
a vehicle position deciding unit deciding a second position of the vehicle from the first position of the vehicle based on a longitudinal speed and a transverse speed of the vehicle after the predetermined time elapses;
a target position estimating unit estimating a second position of the target based on the second distance and the second position of the vehicle; and
a position comparing unit comparing the first position of the target and the second position of the target to determine whether the target is the moving object.

10. An apparatus for determining motion characteristics of a target, comprising:
a presence determining unit determining whether a target is positioned in front; and
a moving object/movement direction determining unit determining whether the target is a moving object and a movement direction of the target by using a relative speed deviation of the target when it is determined that the target is positioned in front.
